(19) United States
(12) Patent Application Publication
(10) Pub. No.: US 2013/0057680 A1
(43) Pub. Date: Mar. 7, 2013

(54) SYSTEM AND METHOD FOR MEASURING A COLOUR VALUE OF A TARGET

(71) Applicant: Rex Hesline, Launceston (AU)

(72) Inventor: Rex Hesline, Launceston (AU)

(73) Assignee: AUTECH RESEARCH PTY LTD., Launceston, Tasmania (AU)

(21) Appl. No.: 13/582,959

(22) PCT Filed: Mar. 4, 2011
(86) PCT No.: PCT/AU2011/000249

§ 371 Date: Nov. 19, 2012

(30) Foreign Application Priority Data
Mar. 6, 2010 (AU) 2010900944

(51) Int. Cl. G06K 9/62; H04N 7/18

(52) U.S. Cl. 348/135; 348/E07.085

(57) ABSTRACT

A method and system for measuring a colour value of a target comprising a mobile communication device having a camera with a sensor arranged to detect wavelengths of incident light reflected from an illuminated target. The mobile communication device also has a processor arranged to measure a colour value of the target based on the detected wavelengths received from the sensor, and to output the measured colour value of the target for display on a display of the mobile communication device.

### FIELD OF THE INVENTION

The present invention relates to a method and system for measuring a colour value of a target, and particularly to measuring and displaying a colour value using a mobile communication device.

### BACKGROUND OF THE INVENTION

Colour measurement devices, such as colorimeters or spectrophotometers, are commonly used to quantify our perception of colours of objects by measuring colour values of the objects. The measured colour values can then be used to describe a colour of an object consistently to users of the measurement devices. In addition, the measurement devices enable the users, each not perceiving the colour of the object at the same time, to describe the colour consistently with reference to a standard illuminant. However, there are a number of problems associated with these colour measurement devices such as portability and consistency of results across different types of measurement devices.

On existing type of colour measurement device is a tristimulus colorimeter which is commonly used to measure and/or calculate tristimulus values of a colour of a target; that is, values signifying Red, Blue and Green wavelength components of the colour. These colorimeters enable the measured tristimulus values to be displayed to users of the colorimeter for comparison with other measured tristimulus values. However, while these colorimeters can be made portable, users can only compare tristimulus values of objects measured by and displayed on the colorimeters.

### SUMMARY OF THE INVENTION

According to one aspect of the invention there is provided a system for measuring a colour value of a target comprising:
a mobile communication device having a camera with a sensor arranged to detect wavelengths of incident light reflected from an illuminated target,
wherein the mobile communication device has a processor arranged to measure a colour value of the target based on the detected wavelengths received from the sensor, and to output the measured colour value of the target for display on a display of the mobile communication device.

In an embodiment, the mobile communication device is operable to allow for the communication of the colour value between other mobile devices or Internet based applications.

In an embodiment, a light source is arranged to illuminate the target, preferably uniformly in intensity over a surface of the target. In an arrangement, the light source is disposed in the mobile communication device and comprises at least one LED. In the arrangement, the or each LED is operable to illuminate the target with light simulating daylight. In one example, the at least one LED comprises a white LED operable to emit light with a visible electromagnetic spectrum simulating daylight. In another example, the at least one LED comprises Red, Blue and Green LEDs which, in combination, emit light with a visible electromagnetic spectrum simulating daylight.

In an embodiment, the or each LED is operable at a designated power corresponding to a distance from the target so that the target is illuminated at a designated intensity. In this embodiment, the processor is further arranged to determine the corresponding designated power to be supplied to the or each LED.

In an alternative embodiment, the light source is ambient light and the processor is further arranged to determine the intensity of the ambient light to transform the detected wavelengths received from the sensor accordingly to measure the colour value of the target.

In an embodiment, the or each LED is a CIE Standard Illuminant. It will be appreciated by those persons skilled in the art that a CIE Standard Illuminant is a known profile or electromagnetic spectrum of visible light, for example D65. In another example, the or each LED is a D50 Illuminant. With reference to the above example, Red, Blue and Green LEDs may, in combination, emit light with a visible electromagnetic spectrum according to the D65 spectrum.

In an embodiment, the sensor comprises a polychromatic sensor. In this embodiment, the sensor is operable to detect wavelengths from the visible spectrum of light. In an example, the sensor is operable to detect designated wavelengths from the visible spectrum of light, such as Red, Blue and Green. Alternatively, the sensor is operable to detect designated wavelengths at designated intervals, such as every 10 nm between 400 nm and 700 nm of the visible spectrum.

In another embodiment, the sensor comprises a sensor for detecting Red wavelengths, a sensor for detecting Blue wavelengths, and a sensor for detecting Green wavelengths. It will also be appreciated by those skilled in the art that the sensor may comprise components such as a filter for filtering designated wavelengths of light, an amplifier and a photodetector.

In an embodiment, the sensor comprises an array of CCD sensors. Alternatively, the sensor comprises an array of CMOS sensors. It will be appreciated that the sensor may also comprise other sensors such as HCMOS sensors.

In an embodiment, the processor is further arranged to measure the colour value of the target based on respective detected Red, Blue and Green wavelengths received from the or each sensor.

In an embodiment, the processor is further arranged to provide chromaticity coordinates of a colour space based on the detected Red, Blue and Green wavelengths. In an example, the colour space comprises a CIE XYZ colour space. In a further example, the colour space comprises a sRGB colour space. It will be appreciated by those persons skilled in the art that chromaticity coordinates of one colour space may be transformed to chromaticity coordinates of another colour space.

In an embodiment, the processor is further arranged to transform sRGB colour space chromaticity coordinates to Colour, Saturation and Lightness values. In this embodiment, the sRGB chromaticity coordinates are transformed to comprise a designated Colour value based on a perceived colour or hue of the target, a Saturation value based on the degree of purity of the perceived colour reflected from the target, and a Lightness value based on the luminance of the light reflected from the target.

In this embodiment, the display of the mobile communication device is arranged to display the measured colour value of the target comprising the transformed Colour, Saturation and Lightness values relative to other Colour, Saturation and Lightness values. In addition, the display may be further arranged to display a colour based on the measured colour value of the target. In an arrangement, the display is further arranged to display the colour based on the measured colour value of the target relative to other colours based on other Colour, Saturation and Lightness values. For example, the displayed colour may be displayed relative to other displayed colour having different Colour (or hue) values but having the same Saturation and Lightness values.

In an embodiment, the mobile communication device comprises a mobile phone. However, it will be appreciated by those persons skilled in the art that the mobile communication device may include a mobile computer, incorporating a processor, camera and display, which is arranged to communicate over a network (e.g. 3G).

According to another aspect of the present invention there is provided a mobile communication device for measuring a colour value of a target comprising:
a camera with a sensor arranged to detect wavelengths of incident light reflected from an illuminated target;
a processor arranged to measure a colour value of the target based on the detected wavelengths received from the sensor, and to output the measured colour value of the target for display; and
a display arranged to display the measured colour value.

According to another aspect of the present invention there is provided a method for measuring a colour value of a target, the method comprising:
locating a mobile communication device comprising a camera, processor and display adjacent an illuminated target;
detecting wavelengths of incident light reflected from the illuminated target using a sensor of the camera;
measuring, using the processor, a colour value of the target based on the detected wavelengths received from the sensor,
outputting, using the processor, the measured colour value of the target for display; and
displaying, using the display, the measured colour value of the target.

According to another aspect of the present invention there is provided computer program code which when executed implements the above method.

According to another aspect of the present invention there is provided a computer readable medium comprising the above program code.

According to another aspect of the present invention there is provided a data file comprising the above program code.

### BRIEF DESCRIPTION OF THE DRAWINGS

In order that the invention can be more clearly ascertained, embodiments will now be described, by way of example, with reference to the accompanying drawings, in which:

FIG. 1 is a schematic view of a system for measuring a colour value of a target according to an embodiment of the invention;

FIG. 2 is a further schematic view of a system for measuring a colour value of a target according to an embodiment of the invention showing a light source;

FIG. 3 is further schematic view of the system of FIG. 1 or FIG. 2 showing a measured colour value displayed on a display of a mobile communication device;

FIG. 3 is further schematic view of the system of FIG. 1 or FIG. 2 showing a measured colour value displayed on a display of a mobile communication device;

FIG. 4 is a flow chart of a method implemented by the system of FIG. 1 or FIG. 2; and

FIG. 5 is a further schematic view of a system for measuring a colour value of a target according to an embodiment of the invention; and

FIG. 6 is further schematic view of the system of FIG. 1, FIG. 2 or FIG. 5 showing a measured colour value displayed on a display of a mobile communication device.

### DETAILED DESCRIPTION

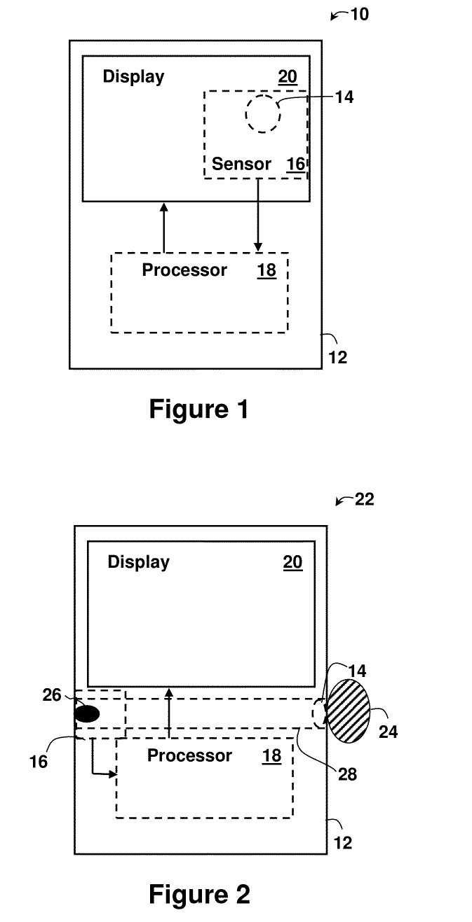

According to an embodiment of the present invention, there is provided a system 10 for measuring a colour value of a target (not shown in FIG. 1) including a mobile communication device 12, such as a mobile phone or a mobile computer (herein referred to as a mobile phone).

The mobile communication device 12 includes a camera 14, sensor 16, processor 18, and display 20. In the embodiment, the sensor 16 is arranged to detect wavelengths of incident light reflected from the target, which is illuminated by a light source (not shown in FIG. 1). As described above, the light source may be ambient light or direct light, such as light emitted from an LED or an incandescent lamp. In a further embodiment, the LED is disposed on the mobile phone 12 for flash photography and is configured as the light source by the processor 18. That is, the processor 18 is arranged to configure the power supplied to the LED based on a current illumination of the target (measured or selected) and/or a distance, so that the target can be illuminated at a designated intensity.

In the embodiment, the processor 18 is arranged to measure a colour value of the target based on the detected wavelengths received from the sensor. Subsequently, the processor 18 outputs the measured colour value for display on the display 20.

In the embodiment shown in FIG. 1, the camera 14 is disposed in the mobile phone 12. In an example, the camera 14 is a CCD or CMOS camera used for digital imaging of targets (e.g. taking digital photographs of targets). In the example, the camera 14 includes an aperture (not shown) to allow light to pass therethrough onto the CCD or CMOS sensor 16, which may be an array of sensors corresponding to a two dimensional grid of pixels forming an image of the target. In addition, the array of CCD or CMOS sensors are operable to represent each pixel by its Red, Green, and Blue colour components and their respective intensities. Furthermore, the array of sensors 14 may additionally employ filters or beam splitting prisms to split the incident light into the respective wavelength groups. In any case, the array of sensors 14 detect wavelengths of light reflected off a surface of a target and their respective intensities for the processor 18 to measure a colour value of the surface of the target. The measured colour value can then be displayed to a user of the mobile phone 12 and may be used by other programs implemented by the processor 18 or communicated over a telecommunications network to other users.

For example, a program residing on the mobile phone 12 may be arranged to compare measured colour values with known colour values for a particular target. In one application, for example, the target surface is the skin of a grape and a user can compare a measured colour value to determine ripeness of the grape. In another application, the target surface is a shoe colour and a user can search store inventories within a local or international GPS range for other coloured products for sale, such as lipstick or nail polish or dresses in any range of colours determined by the user to harmonise with the shoe colour. In another application, the target surface is a skin pigment defect identified by a medical practitioner which may be measured and saved to a device for later retrieval and comparison to new measurements by the user and communicated to a medical practitioner's display device for opinion.

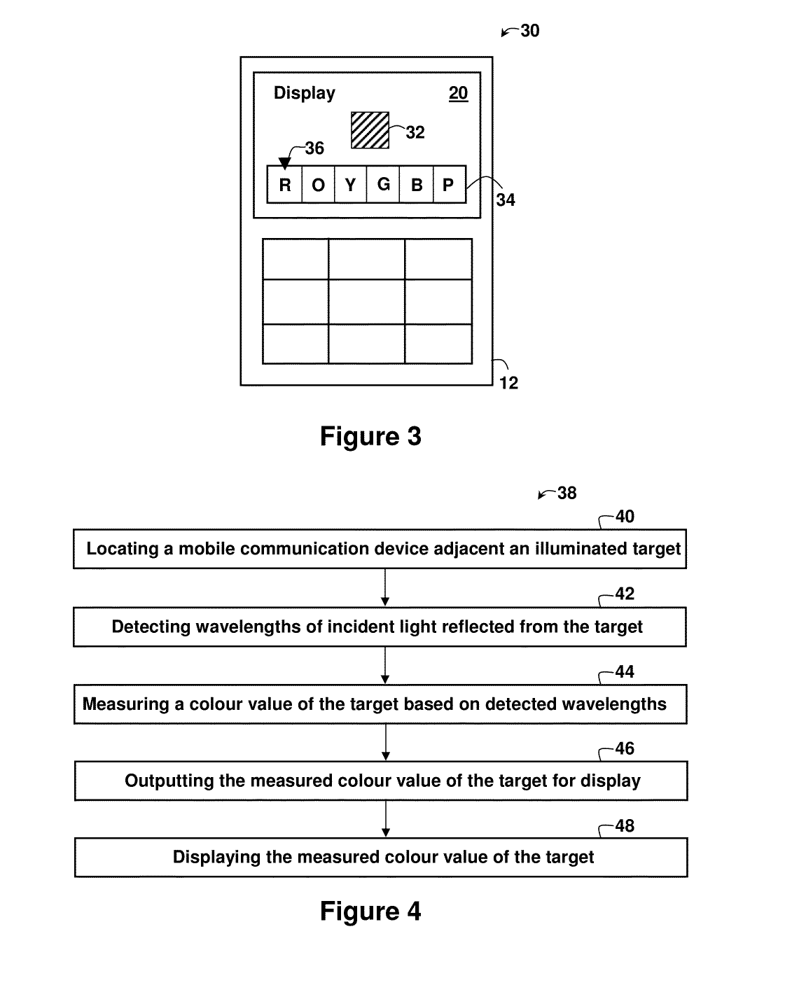

In another example, the measured colour value can be communicated to another user for display on their mobile phone for their opinion regarding the measured colour value of the target. Furthermore, the measured colour value can be displayed as a colour. With respect to this example, the measured colour value is displayed as a colour relative to other colours displayed on the mobile phone so a user can review the measured colour value as a colour of a target with reference to other colours (as shown in FIG. 3).

The abovementioned examples require specific software applications residing on the mobile phone 12. These are typically stored as program code in a memory (not shown) of the mobile phone 12 accessible by the processor 18. Herein the term “processor” is used to refer generically to any device that can process stored instructions and may include: a microprocessor, microcontroller, programmable logic device or other computational device.

FIG. 2 shows another embodiment of a system 22 for measuring a colour value of a target. In this embodiment, the mobile communication device 12 is adjacent a target 24 so that, in use, a surface of the target can have its colour value measured. Furthermore, in use, a light source 26 is operable to illuminate the surface of the target 24 so that the reflected light can strike the sensor 16. In the embodiment, the light source 26 is an LED which is operable at a designated power at a designated distance from the target so that the target is illuminated at a designated intensity. Also, the processor 16 is arranged to determine the corresponding designated power to be supplied to the LED 26 based on the distance of a light tube 28 extending from the LED 26 to an aperture of the camera 14.

In an example, the mobile phone 12 is located adjacent the target 24 so that the target can be illuminated at the designated intensity and no ambient light can be detected by the sensor 16. In this embodiment, the LED 26 can operate as a CIE Standard Illuminant, such as a D65 or D50 Illuminant, to ensure consistency of colour value measurements.

As described, the display 20 is arranged to display the measured colour value to a user of the mobile phone 12. In the embodiment shown in FIG. 3, the measured colour value is displayed to a user as a colour 32 relative to other displayed colours on a colour strip 34 using an indicator 36 to indicate a position of the colour on the colour strip. In this embodiment, the displayed colour 32 may be displayed relative to other displayed colour having different Colour (or hue) values. That is, the colour strip is arranged so that a number of human perceptible hues between Red and Purple are displayed on the colour strip and the indicator 36 indicates the hue.

As described, in order to display the measured colour value as a colour, the processor 18 is arranged to measure the colour value of the target based on respective detected Red, Blue and Green wavelengths received from the sensor 16, and to provide chromaticity coordinates of a colour space based on the detected Red, Blue and Green wavelengths. In one example, the colour space comprises a CIE XYZ colour space however it is envisaged that a CIE RGB colour space may also be used. In the example, the detected Red, Blue and Green wavelengths are converted to CIE XYZ colour space coordinates. These coordinates are then further transformed to sRGB coordinates for further manipulation. To facilitate this manipulation, the sRGB coordinates are then transformed into Colour, Saturation and Lightness values so that the displayed colour 32 can be displayed relative to other colours on the colour strip 34 as described above. Thus, in one example, the colours displayed on the colour strip 34 have saturation and lightness values matching the transformed saturation and lightness values of the measured colour value to compare hues. It will be appreciated by those skilled in the art that the colour strip may be displayed with other configurations of Saturation and Lightness values to provide for varied comparisons. For example, the displayed colour strip 34 may be displayed with a single hue and varying Lightness values to compare lightness. Furthermore, the Saturation and Lightness values may be user configurable for improved comparison.

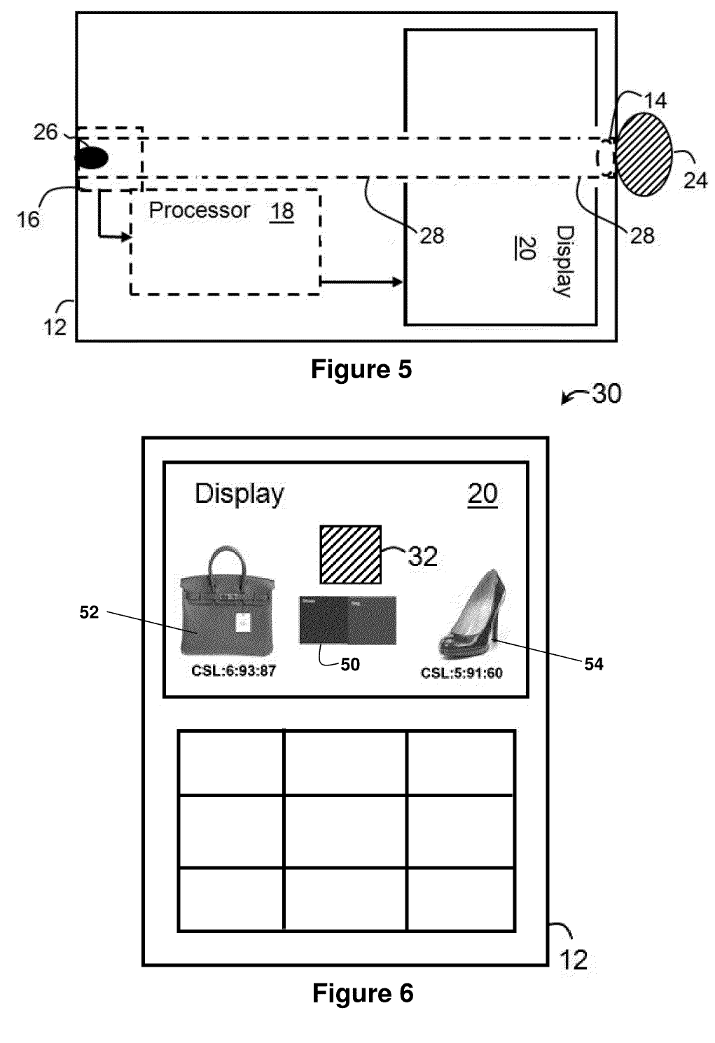

FIG. 5 shows another embodiment of the system for measuring a colour value of a target. In this embodiment, the sensor 16 is located at the base of the mobile phone 12 and the light tube 28, extending from the aperture of the camera 14 to the sensor 16 is disposed lengthwise in the mobile phone 12. In use, the target 24 is located at the top so that a surface of the target can have its colour value measured. In addition, the light source 26, operable to illuminate the surface of the target 24, is located at the base of the mobile communication device 12 adjacent the sensor 16. In a further embodiment, the light tube 28 is disposed externally to the mobile phone 12 and comprises the sensor 16, light source 26 and a communication means (not shown) operable to communicate data from the sensor 16 to the processor 18 of the mobile phone 12 so that the measured colour value can be displayed on the display 20.

In one application, target surfaces of objects, such as clothes, can be measured and compared with existing target (e.g. product) colours previously measured and saved to the users' mobile phone 12, such as an existing measured shoe colour and bag colour, for comparison, as shown in FIG. 6. In this application, the mobile phone 12 stores colour values of previously measured products in the form of Colour, Saturation and Lightness (CSL) values, or otherwise obtains the colour values of products over the Internet. In any case, the display 20 of the mobile phone 12 can be used to discern the colour of products objectively. For example, the measure colour 32 of an object, such as a dress, can be compared with the saved colours of a handbag 52 and a shoe 54. In this example, the handbag 52 has CSL values of 6:93:87 and the shoe 54 has CSL values of 5:91:60, which are displayed as colours 50 in the display 20 for a visual comparison.

In a further application, the mobile phone 12 can access networks, such as the Internet, and obtain CSL values of objects previously measured by other users of the system for measuring colour values. In this way, colours of objects can be objectively compared for closeness and for harmonious colour matches, as well for price comparison. The mobile phone 12 is operable to determine and advise harmonious colours based on a measured colour value, such as advising complementary colours to the measured colour, and is further operable to retrieve and display objects having the determine harmonious colours. Thus, for example, a user measures a colour value of a shoe, which is displayed 32 to the user, and the mobile phone 12 subsequently retrieves and displays handbags 52 with harmonious colours to the colour of the shoe in the vicinity of the user, using the GPS co-ordinates of the mobile phone 12 and Internet listings of adjacent stores having characterised their handbags with CSL values.

Referring back to FIG. 4 which illustrates a flow chart of a method 38 implemented by the above described system for measuring a colour value of a target. The method 38 includes locating 40 a mobile communication device adjacent an illuminated target, detecting 42 wavelengths of incident light reflected from the target using a sensor of a camera disposed in the mobile communication device, and measuring 44 a colour value of the target based on the detected wavelengths. The method 38 further includes outputting 46 the measured colour value for display and displaying 48 the measured colour value of the target.

Further aspects of the method will be apparent from the above description of the system. It will be appreciated that at least part of the method will be implemented digitally by a processor of a mobile communication device. Persons skilled in the art will also appreciate that the at least part of the method could be embodied in program code. The program code could be supplied in a number of ways, for example on a tangible computer readable storage medium, such as a disc or a memory or as a data signal (for example, by transmitting it from a server). Persons skilled in the art will appreciate that program code provides a series of instructions executable by the processor.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A system for measuring a colour value of a target comprising:
a mobile communication device having a camera with a sensor arranged to detect wavelengths of incident light reflected from an illuminated target,
wherein the mobile communication device has a processor arranged to measure a colour value of the target based on the detected wavelengths received from the sensor, and to output the measured colour value of the target for display on a display of the mobile communication device.

2. A system as claimed in claim 1, further comprising a light source arranged to illuminate the target, or a light source arranged to illuminate the target and disposed in the mobile communication device.

3. (canceled)

4. (canceled)

5. A system as claimed in claim 2, wherein the light source is operable at a designated power corresponding to a distance from the target so that the target is illuminated at a designated intensity.

6. A system as claimed in claim 2, wherein the light source is operable to illuminate the target with light simulating daylight or comprises one or more CIE Standard Illuminants or comprises one or more D65 CIE Standard Illuminants.

7. (canceled)

8. (canceled)

9. A system as claimed in claim 5, wherein the processor is further arranged to determine the corresponding designated power to be supplied to the light source.

10. A system as claimed in claim 1, wherein the sensor comprises a polychromatic sensor or the sensor comprises a first sensor for detecting Red wavelengths, a second sensor for detecting Blue wavelengths, and a third sensor for detecting Green wavelengths.

11. (canceled)

12. A system as claimed in claim 10, wherein the sensor comprises a polychromatic sensor and the processor is further arranged to measure the colour value of the target based on respective detected Red, Blue and Green wavelengths received, or the sensor comprises a first sensor for detecting Red wavelengths, a second sensor for detecting Blue wavelengths, and a third sensor for detecting Green wavelengths and the processor is further arranged to measure the colour value of the target based on respective detected Red, Blue and Green wavelengths received from the first, second and third sensors.

13. A system as claimed in claim 1, wherein the processor is further arranged to provide chromaticity coordinates of a colour space based on detected Red, Blue and Green wavelengths.

14. A system as claimed in claim 13, wherein the colour space comprises a CIE XYZ colour space or a sRGB colour space.

15. (canceled)

16. A system as claimed in claim 14, wherein the colour space comprises a sRGB colour space and the processor is further arranged to transform the sRGB colour space chromaticity coordinates to Colour, Saturation and Lightness values.

17. A system as claimed in claim 16, wherein the measured colour value of the target comprises the transformed Colour, Saturation and Lightness values.

18. A system as claimed in claim 16, arranged to display on the display the measured colour value of the target comprising the transformed Colour, Saturation and Lightness values relative to other Colour, Saturation and Lightness values.

19. A system as claimed in claim 1, wherein the display is further arranged to display a colour based on the measured colour value of the target, or to display a colour based on the measured colour value of the target relative to other colours based on other Colour, Saturation and Lightness values.

20. (canceled)

21. A system as claimed in claim 1, wherein the sensor comprises an array of CCD sensors or an array of CMOS sensors.

22. (canceled)

23. A system as claimed in claim 1, wherein the mobile communication device comprises a mobile phone.

24. A mobile communication device for measuring a colour value of a target comprising:
a camera with a sensor arranged to detect wavelengths of incident light reflected from an illuminated target;
a processor arranged to measure a colour value of the target based on the detected wavelengths received from the sensor, and to output the measured colour value of the target for display; and
a display arranged to display the measured colour value.

25. A method for measuring a colour value of a target, the method comprising:
locating a mobile communication device comprising a camera, processor and display adjacent an illuminated target;
detecting wavelengths of incident light reflected from the illuminated target using a sensor of the camera;
measuring, using the processor, a colour value of the target based on the detected wavelengths received from the sensor,
outputting, using the processor, the measured colour value of the target for display; and
displaying, using the display, the measured colour value of the target.

26. Computer program code which when executed implements the method of claim 25.

27. A computer readable medium comprising the program code of claim 26.

28. A data file comprising the program code of claim 26.
